(19) United States
(12) Patent Application Publication
(10) Pub. No.: US 2025/0246879 A1
(43) Pub. Date: Jul. 31, 2025

(54) FUSE GROUP ASSEMBLY FOR A POWER CONVERTER ASSEMBLY

(71) Applicant: Caterpillar Inc., Peoria, IL (US)

(72) Inventors: Raghu BANDARU, Peoria, IL (US); Jason Prakash WIGG, Ridgley (AU); William Medard BRO, Nashville, TN (US); Sureshkumar BABU, Chennai (IN); Beau James BERNING, Naperville, IL (US)

(73) Assignee: Caterpillar Inc., Peoria, IL (US)

(21) Appl. No.: 18/429,143

(22) Filed: Jan. 31, 2024

(51) Int. Cl. H02B 1/18; B60R 16/03; H02B 1/21

(52) U.S. Cl. CPC H02B 1/18; B60R 16/03; H02B 1/21

(57) ABSTRACT

A fuse group assembly may include a first bus bar, a second bus bar in a stepped arrangement with the first bus bar, a first support plate arranged on the second bus bar, a second support plate in a stepped arrangement with the first support plate, a first fuse having a first end electrically connected to the first bus bar and a second end supported by the first support plate, and a second fuse having a first end electrically connected to the second bus bar and a second end supported by the second support plate.

### TECHNICAL FIELD

The present disclosure relates generally to electric drive machines and, for example, to a fuse group assembly for a power converter assembly.

### BACKGROUND

Work machines, such as off-highway trucks or loaders, are commonly used in mining, heavy construction, quarrying, and other applications. One advance that has improved efficiency associated with the use of work machines is the adoption of electric drive systems. Relative to mechanical drive systems, electric drive systems typically require less maintenance and thus, have lower life cycle costs. In one example, an electric drive system may include a prime mover (e.g., an internal combustion engine) that drives a power generator. The power generator produces electrical power, conditioned by a power circuit, that is ultimately used to drive an electric motor and/or power other components of a work machine (e.g., a lighting system, a heating, ventilation, and air conditioning (HVAC) system, or the like). The distribution of high-voltage electrical power to various components of the work machine may be handled by a power distribution unit (PDU). The PDU may introduce additional high-voltage access points and/or high-voltage cabling (e.g., between the PDU and a power converter) on the work machine, may include high-voltage terminals that are difficult to access for servicing, and/or may occupy excessive space.

China Patent No. CN 216819731U (the '731 patent) discloses an inverter that includes a shell and a fuse box. The shell includes a shell body and a cover plate, where one side of the shell body is provided with an accommodating groove for accommodating an electronic device, and the cover plate is covered at a notch of the accommodating groove. The '731 patent does not describe the configuration or internal structure of the fuse box.

The power converter assembly of the present disclosure solves one or more of the problems set forth above and/or other problems in the art.

### SUMMARY

A power converter assembly may include a casing, a power converter in the casing, a first connection post and a second connection post in the casing and electrically connected to the power converter, a gland housing on the casing defining a cable gland, and a fuse group assembly disposed in the gland housing. The fuse group assembly may include a first bus bar electrically connected to the first connection post, a second bus bar, in a stepped arrangement with the first bus bar, electrically connected to the second connection post, a first support plate arranged on the second bus bar, a second support plate in a stepped arrangement with the first support plate, a first fuse having a first end electrically connected to the first bus bar and a second end supported by the first support plate, and a second fuse having a first end electrically connected to the second bus bar and a second end supported by the second support plate.

A fuse group assembly may include a first bus bar, a second bus bar in a stepped arrangement with the first bus bar, a first support plate arranged on the second bus bar, a second support plate in a stepped arrangement with the first support plate, a first fuse having a first end electrically connected to the first bus bar and a second end supported by the first support plate, and a second fuse having a first end electrically connected to the second bus bar and a second end supported by the second support plate.

A machine may include a power source configured to output electrical power, a power converter electrically coupled to the power source, and a fuse group assembly. The fuse group assembly may include a first bus bar electrically connected to one of a positive terminal or a negative terminal of the power converter, a second bus bar, in a stepped arrangement with the first bus bar, electrically connected to the other of the positive terminal or the negative terminal of the power converter, a first support plate arranged on the second bus bar, a second support plate in a stepped arrangement with the first support plate, a first fuse having a first end electrically connected to the first bus bar and a second end supported by the first support plate, and a second fuse having a first end electrically connected to the second bus bar and a second end supported by the second support plate.

### BRIEF DESCRIPTION OF THE DRAWINGS

FIG. 1 is a perspective view of an example machine.

FIG. 2 is a schematic illustration of a power converter assembly and one or more machine accessories.

FIG. 3 is a perspective view of an example fuse group assembly.

FIG. 4 is a perspective view of an example fuse group assembly mounted to a housing base.

FIG. 5 is a perspective view of an example fuse group assembly disposed in a gland housing.

FIG. 6 is a perspective view of an example power converter assembly.

### DETAILED DESCRIPTION

This disclosure relates to a power converter assembly, which is applicable to any machine that employs an electric drive.

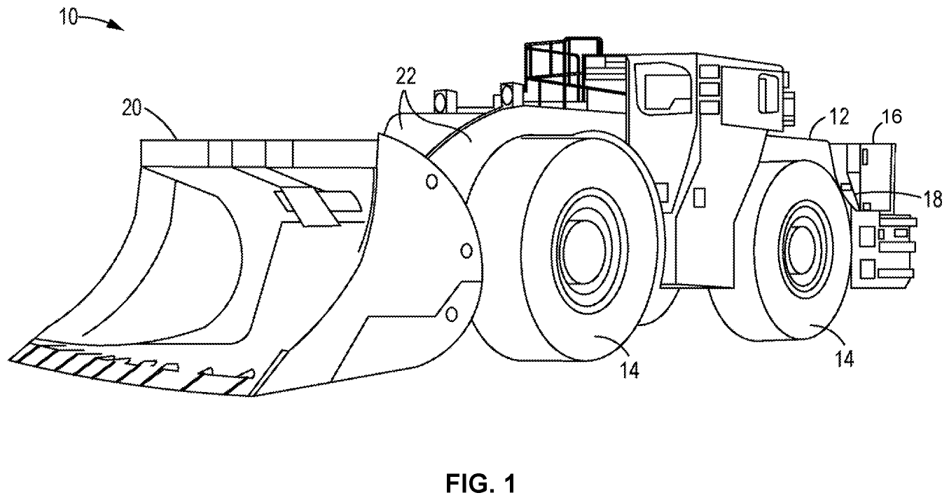

FIG. 1 is a perspective view of an example machine 10. The machine 10 may be a work machine. For example, the machine 10 may perform earth moving, excavation, or another operation associated with an industry, such as mining. As an example, as illustrated in FIG. 1, the machine 10 is a load-haul-dump (LHD) loader. However, the machine 10 may be another type of machine, such as a compactor machine, a paving machine, a cold planer, a grading machine, a backhoe loader, a wheel loader, a harvester, an excavator, a motor grader, a skid steer loader, a tractor, a dozer, an underground articulated truck, or an off-highway truck, among other examples. The machine 10 may be a diesel-electric machine (e.g., that includes a diesel engine and electrical systems, such as generators, to convert power from the engine to electricity for propulsion and/or operation of the machine 10). Additionally, or alternatively, the machine 10 may be a battery-electric machine (e.g., that uses electric power stored in one or more batteries for propulsion and/or operation of the machine 10).

The machine 10 may include a frame 12 supported by a plurality of ground-engaging members 14, which are illustrated as wheels. Additionally, or alternatively, the ground-engaging members 14 may include track assemblies, skids, or the like. The ground-engaging members 14 are used to propel the machine 10 over a work surface.

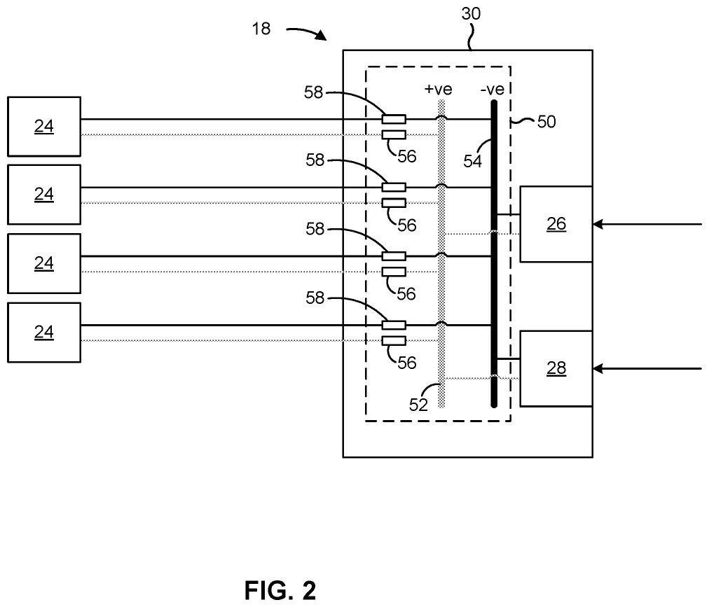

The machine 10 includes a power source 16 configured to output electrical power, and a power converter assembly 18, electrically coupled to the power source 16, to provide power to the ground-engaging members 14. For example, the power source 16 may provide power to an electric motor (not shown) of the machine 10 and/or one or more machine accessories (described in connection with FIG. 2) via the power converter assembly 18. The power source 16 may include an internal combustion engine (e.g., a diesel engine) and an electrical generator coupled to the engine (e.g., in a diesel-electric machine configuration). Additionally, or alternatively, the power source 16 may include one or more batteries (e.g., in a battery-electric machine configuration).

The machine 10 may further include an implement 20 mounted to the frame 12 that may be used to manipulate and/or transport work material at a worksite. For example, the implement 20 may be mounted to the frame 12 by a pair of lift arms 22. The implement 20 may include a bucket, as shown. In some implementations, the power source 16 and the power converter assembly 18 may provide power to the implement 20 (e.g., via a hydraulic system of the machine 10).

As indicated above, FIG. 1 is provided as an example. Other examples may differ from what is described with regard to FIG. 1.

FIG. 2 is a schematic illustration of the power converter assembly 18 and one or more machine accessories 24 (e.g., loads). The power converter assembly 18 may include a first power converter 26 and/or a second power converter 28 in a casing 30. The first power converter 26 or the second power converter 28 may include power conversion circuitry, such as an inverter, a rectifier, a regulator, and/or a transformer, among other examples. For example, the first power converter 26 may include a traction inverter and the second power converter 28 may include a generator inverter. The first power converter 26 and/or the second power converter 28 may be configured for bi-directional power flow. The first power converter 26 and/or the second power converter 28 may receive an electrical input from the power source 16. In some modes of operation, the electrical input may be an alternating current (AC) electrical input, and the first power converter 26 and/or the second power converter 28 may produce a direct current (DC) output. An output of the first power converter 26 and/or the second power converter 28 may be a high-voltage output, such as at least 500 volts (V), at least 700 V (e.g., 715 V), or 1000 V.

The power converter assembly 18 includes a fuse group assembly 50 in the casing 30. In some implementations, the fuse group assembly 50 may receive a DC electrical input from the first power converter 26 and/or the second power converter 28. The fuse group assembly 50 includes a first bus bar 52 and a second bus bar 54. The first bus bar 52 may be electrically connected to one of a positive terminal or a negative terminal of the first power converter 26 and/or the second power converter 28, and the second bus bar 54 may be electrically connected to the other of the positive terminal or the negative terminal of the first power converter 26 and/or the second power converter 28. For example, the first bus bar 52 may be a positive bus bar of the fuse group assembly 50 and the second bus bar 54 may be a negative bus bar of the fuse group assembly 50.

The fuse group assembly 50 further includes one or more (e.g., a plurality of) first fuses 56 and one or more (e.g., a plurality of) second fuses 58. The first fuses 56 may be electrically connected to the first bus bar 52. For example, the first fuses 56 may be positive fuses electrically connected to a positive terminal of the first power converter 26 and/or the second power converter 28. The second fuses 58 may be electrically connected to the second bus bar 54. For example, the second fuses 58 may be negative fuses electrically connected to a negative terminal of the first power converter 26 and/or the second power converter 28.

The fuse group assembly 50 provides power distribution to the machine accessories 24 via the bus bars 52, 54. Moreover, each machine accessory 24 has a fuse 56 on a positive side of the machine accessory 24 and a fuse 58 on a negative side of the machine accessory 24. For example, the fuse 56 is configured to interrupt a first current path on the positive side of the machine accessory 24, and the fuse 58 is configured to interrupt a second current path on the negative side of the machine accessory 24. This dual pole protection protects against a second ground fault, which may occur while a first ground fault is occurring, that could pass large currents through the cables for the machine accessories 24 and cause cable failure. A machine accessory 24 may be configured to receive a high-voltage electrical input. A machine accessory 24 may include a DC-DC voltage converter (e.g., to step down a high-voltage electrical input, such as to 24 V), an HVAC compressor, and/or a cooler fan, among other examples.

As indicated above, FIG. 2 is provided as an example. Other examples may differ from what is described with regard to FIG. 2.

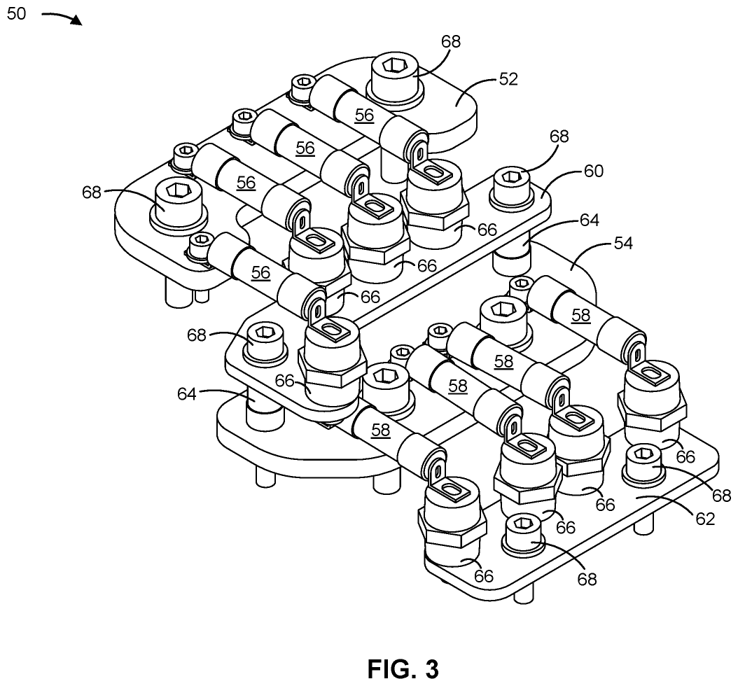

FIG. 3 is a perspective view of an example fuse group assembly 50. In addition to the bus bars 52, 54 and the fuses 56, 58, the fuse group assembly 50 may include a first support plate 60 and a second support plate 62. The bus bars 52, 54 and the support plates 60, 62 may be in an arrangement that provides support and electrical connection for the fuses 56, 58. Moreover, the arrangement of the bus bars 52, 54 and the support plates 60, 62 may provide compactness for the fuse group assembly 50. As an example, the first bus bar 52 may be in a stepped arrangement with the second bus bar 54. Similarly, the first support plate 60 may be in a stepped arrangement with the second support plate 62. Moreover, the first support plate 60 may be arranged on the second bus bar 54. For example, the first support plate 60 may be raised from a surface of the second bus bar 54 by one or more spacers 64 arranged between the second bus bar 54 and the first support plate 60.

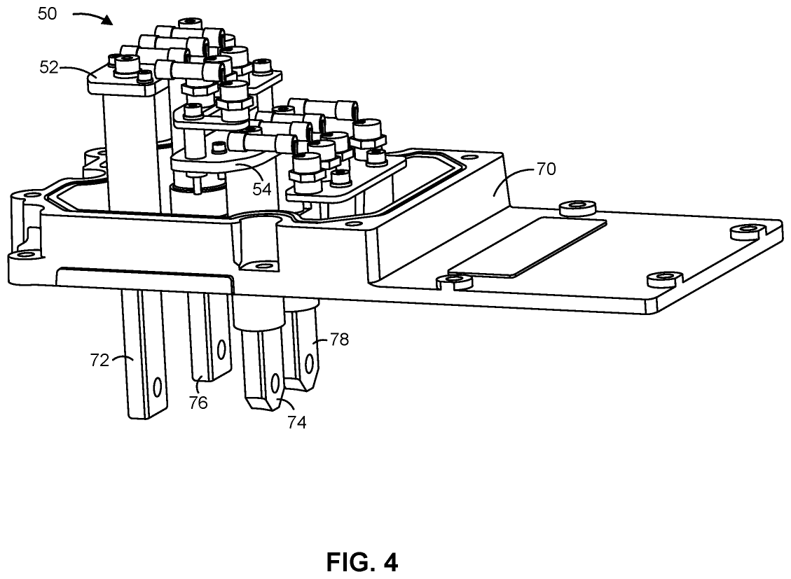

The first bus bar 52, the second bus bar 54, the first support plate 60, and the second support plate 62 may together define a series of steps. For example, the first bus bar 52 and the first support plate 60 may have a stepped arrangement, the first support plate 60 and the second bus bar 54 may have a stepped arrangement, and the second bus bar 54 and the second support plate 62 may have a stepped arrangement. As an example, the first bus bar 52 may define a first step, the first support plate 60 may define a second step descending from the first step, the second bus bar 54 may define a third step descending from the second step, and the second support plate 62 may define a fourth step descending from the third step. Stated differently, the first bus bar 52 is positioned at a first height (e.g., relative to a reference plane, such as the housing base described in connection with FIG. 4), the first support plate 60 is positioned at a second height lower than the first height, the second bus bar 54 is positioned at a third height lower than the second height, and the second support plate 62 is positioned at a fourth height lower than the third height.

In one example as shown, the first bus bar 52 has a C-shape, the first support plate 60 has an L-shape, the second bus bar 54 has a D-shape, and the second support plate 62 has a rectangular-shape. This configuration of the bus bars 52, 54 and the support plates 60, 62 provides space savings; however, other configurations may be used. The bus bars 52, 54 may be composed of an electrically-conductive material, such as a metal or a metal alloy. The support plates 60, 62 may be composed of an electrically-conductive material (e.g., that is the same as, or different from, the material of the bus bars 52, 54) or an electrically-insulating material, such as a plastic.

Each fuse 56, 58 may include a first electrical contact at a first end of the fuse 56, 58 and a second electrical contact at a second end of the fuse 56, 58. As described herein, the first fuses 56 are electrically connected to the first bus bar 52 (e.g., to provide overcurrent protection at positive sides of the machine accessories 24). For example, a fuse 56 may be attached to the first bus bar 52 (e.g., by a fastener, such as a bolt). Moreover, a fuse 56 may have a first end (e.g., an electrical contact at the first end) attached and/or electrically connected to the first bus bar 52, and a second end (e.g., an electrical contact at the second end) supported by the first support plate 60, as shown. For example, the fuse 56 may be supported on an insulating pillar 66 projecting from the first support plate 60 (e.g., thereby resolving the relative height difference between the first bus bar 52 and the first support plate 60). The insulating pillar 66 may be composed of an electrically-insulating material, such as plastic. In some implementations, the insulating pillar 66 may include a fastener, such as a bolt.

As shown, at least one of the first fuses 56 may have a staggered arrangement with respect to a remainder of the first fuses 56 (e.g., which may be arranged in a row). For example, one or more of the first fuses 56 may be attached to a spine of the C-shaped first bus bar 52 and one or more of the first fuses 56 may be attached to one or more arms extending from the spine of the C-shaped first bus bar 52. Thus, one or more of the first fuses 56 may be supported on the long arm of the L-shaped first support plate 60 and one or more of the first fuses 56 may be supported on the short arm of the L-shaped first support plate 60. This configuration provides space savings and facilitates a compact form factor for the fuse group assembly 50.

As described herein, the second fuses 58 are electrically connected to the second bus bar 54 (e.g., to provide overcurrent protection at negative sides of the machine accessories 24). For example, a fuse 58 may be attached to the second bus bar 54 (e.g., by a fastener, such as a bolt). Moreover, a fuse 58 may have a first end (e.g., an electrical contact at the first end) attached and/or electrically connected to the second bus bar 54, and a second end (e.g., an electrical contact at the second end) supported by the second support plate 62, as shown. For example, the fuse 58 may be supported on an insulating pillar 66 projecting from the second support plate 62 (e.g., thereby resolving the relative height difference between the second bus bar 54 and the second support plate 62). At least one of the second fuses 58 may have an angled orientation with respect to another of the second fuses 58 to make space for one or more fasteners 68, thereby facilitating a compact form factor for the fuse group assembly 50.

As shown, fasteners 68 may extend through the first bus bar 52, the second bus bar 54, and/or the second support plate 62. The fasteners 68 can be used to attach the fuse group assembly 50 to the casing 30 of the power converter assembly 18 and/or to connection posts of the power converter assembly 18, as described in connection with FIG. 4.

As indicated above, FIG. 3 is provided as an example. Other examples may differ from what is described with regard to FIG. 3.

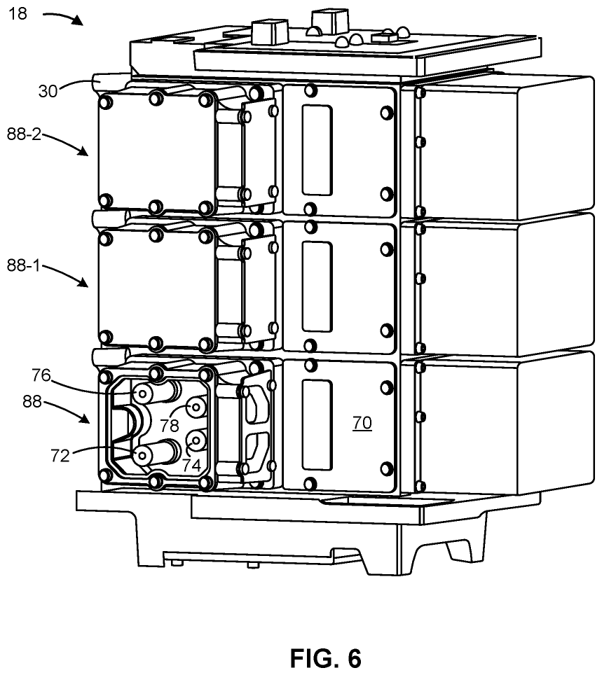

FIG. 4 is a perspective view of the example fuse group assembly 50 mounted to a housing base 70. In some contexts, the housing base 70 may be referred to as a “dog house.” The housing base 70 is a part of the casing 30 of the power converter assembly 18. For example, the housing base 70 may cover a receptacle in the casing 30, as described in connection with FIG. 6.

The power converter assembly 18 may further include a first set of connection posts (e.g., high-voltage terminals), extending through the housing base 70, that includes a first connection post 72 and a second connection post 74. The connection posts 72, 74 may be electrically connected to the first power converter 26. For example, the first connection post 72 may be electrically connected to one of a positive terminal or a negative terminal of the first power converter 26, and the second connection post 74 may be electrically connected to the other of the positive terminal or the negative terminal of the first power converter 26. As an example, the first connection post 72 may be electrically connected to the positive terminal and the second connection post 74 may be electrically connected to the negative terminal.

The first connection post 72 may be attached and/or electrically connected to the first bus bar 52 (e.g., thereby electrically connecting the first bus bar 52 to the positive terminal of the first power converter 26) and the second connection post 74 may be attached and/or electrically connected to the second bus bar 54 (e.g., thereby electrically connecting the second bus bar 54 to the negative terminal of the first power converter 26). For example, the first fuses 56 may be attached to a first side of the first bus bar 52, and the first connection post 72 may be attached to a second side of the first bus bar 52 that is opposite the first side of the first bus bar 52 (e.g., by a fastener 68). Continuing with the example, the second fuses 58 may be attached to a first side of the second bus bar 54, and the second connection post 74 may be attached to a second side of the second bus bar 54 that is opposite the first side of the second bus bar 54 (e.g., by a fastener 68).

In addition, the power converter assembly 18 may further include a second set of connection posts (e.g., high-voltage terminals), extending through the housing base 70, that includes a third connection post 76 and a fourth connection post 76 electrically connected to the first bus bar 52 and the second bus bar 54, respectively, in a similar manner as the first set of connection posts. The second set of connection posts may be electrically connected to the second power converter 28, in a similar manner as the first set of connection posts electrically connect to the first power converter 26. Alternatively, both the first set of connection posts and the second set of connection posts may be electrically connected to one of the first power converter 26 or the second power converter 28 (e.g., the first and second sets of connection posts may be electrically connected to one or more power converters).

As indicated above, FIG. 4 is provided as an example. Other examples may differ from what is described with regard to FIG. 4.

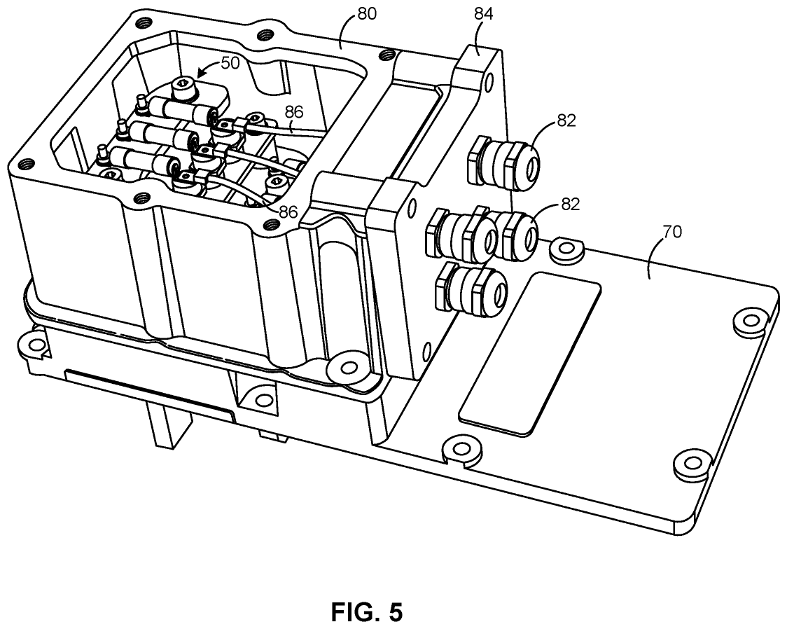

FIG. 5 is a perspective view of the example fuse group assembly 50 disposed in a gland housing 80. The gland housing 80 may be mounted to the housing base 70. The gland housing 80 defines one or more walls that surround the fuse group assembly 50. The gland housing 80 is shown without a top wall (e.g., a cover) for illustration, but in practice may include a top wall. The gland housing 80 may define one or more (e.g., a plurality of) cable glands 82 that project from an exterior of the gland housing 80. For example, the gland housing 80 may include a gland plate 84 (e.g., that defines one wall of the gland housing 80) from which the cable glands 82 project. Contacts within the gland housing 80 that are electrically connected to the fuses 56, 58 may be accessible via the cable glands 82. For example, wires 86 may electrically connect electrical contacts at second ends of the fuses 56, 58 to contacts that are accessible via the cable glands 82 (or the wires 86 may be the contacts that are accessible via the cable glands 82). A machine accessory 24 may be electrically connected to the fuse group assembly 50 via a cable gland 82 (e.g., using a cable of the machine accessory 24 that is inserted into the cable gland 82 and electrically connected to the fuses 56, 58). In this way, the fuse group assembly 50 provides power distribution to the machine accessories 24.

As indicated above, FIG. 5 is provided as an example. Other examples may differ from what is described with regard to FIG. 5.

FIG. 6 is a perspective view of an example power converter assembly 18. As described herein, the power converter assembly 18 includes a casing 30. The casing 30 has a receptacle 88. As described herein, the gland housing 80 (not shown in FIG. 6) that contains the fuse group assembly 50 (not shown in FIG. 6) may be on the housing base 70 for the receptacle 88, and the housing base 70 may be on the casing 30 to cover the receptacle 88 (e.g., the gland housing 80 is on the casing 30). In this configuration, the connection posts 72, 74, 76, 78 may extend within the casing 30 to enable electrical connection of the connection posts 72, 74, 76, 78 to the first power converter 26 and/or the second power converter 28 (e.g., electrical connections of the connection posts 72, 74, 76, 78 to the first power converter 26 and/or the second power converter 28 may be routed through the receptacle 88). Moreover, in this configuration, the gland housing 80 and cable glands 82 may be accessible from an exterior of the casing 30, thereby facilitating connection to the machine accessories 24 and servicing of the fuse group assembly 50 and/or cable glands 82. The casing 30 may include one or more additional receptacles 88-1, 88-2 used in connection with cable routing (e.g., to an electric motor of the machine 10) or for other uses.

In some implementations, a method of assembling the power converter assembly 18 may include mounting the fuse group assembly 50 and the gland housing 80 to the housing base 70, mounting the housing base 70 (having the fuse group assembly 50 and the gland housing 80 mounted thereto) to the casing 30, electrically connecting the bus bars 52, 54 of the fuse group assembly 50 to the connection posts 72, 74, 76, 78, and/or electrically connecting the connection posts 72, 74, 76, 78 to the first power converter 26 and/or the second power converter 28.

As indicated above, FIG. 6 is provided as an example. Other examples may differ from what is described with regard to FIG. 6.

### INDUSTRIAL APPLICABILITY

The power converter assembly described herein may be used with any machine that employs an electric drive. For example, the power converter assembly may be used with a diesel-electric machine or a battery-electric machine that employs an electric motor. In particular, the fuse group assembly of the power converter assembly may be used to distribute power to electrical accessories of a machine, such as a voltage converter, an HVAC compressor, and/or a cooler fan. Generally, the distribution of high-voltage electrical power to electrical accessories may be handled by a PDU that is separate from a power converter assembly. However, the PDU may introduce additional high-voltage access points and/or high-voltage cabling (e.g., between the PDU and a power converter) on a machine, may include high-voltage terminals that are difficult to access for servicing, and/or may occupy excessive space in the machine.

The power converter assembly described herein enables the distribution of high-voltage power to machine accessories, as well as provides overcurrent protection for those accessories, without the use of a separate PDU. For example, the fuse group assembly of the power converter assembly includes bus bars configured to distribute power to multiple machine accessories. Moreover, the fuses of the fuse group assembly are configured to protect both a positive side and a negative side of the machine accessories, thereby protecting against ground faults and the damaging effects thereof. Including the fuse group assembly with a power converter in the power converter assembly, rather than using a separate PDU, reduces high-voltage access points and/or high-voltage cabling of a machine. Moreover, relative to using a separate PDU, the inclusion of the fuse group assembly in the power converter assembly facilitates improved access for servicing high-voltage components. In addition, the configuration of the components of the fuse group assembly results in a small form factor that allows the fuse group assembly to be mounted in a casing of the power converter assembly, thereby allowing the fuse group assembly to be arranged in close proximity to the power converter and conserving space on the machine.

What is claimed is:

1. A power converter assembly, comprising:
a casing;
a power converter in the casing;
a first connection post and a second connection post in the casing and electrically connected to the power converter;
a gland housing on the casing defining a cable gland; and
a fuse group assembly, disposed in the gland housing, comprising:
a first bus bar electrically connected to the first connection post;
a second bus bar, in a stepped arrangement with the first bus bar, electrically connected to the second connection post;
a first support plate arranged on the second bus bar;
a second support plate in a stepped arrangement with the first support plate;
a first fuse having a first end electrically connected to the first bus bar and a second end supported by the first support plate; and
a second fuse having a first end electrically connected to the second bus bar and a second end supported by the second support plate.

2. The power converter assembly of claim 1, wherein the first fuse is attached to a first side of the first bus bar and the first connection post is attached to a second side of the first bus bar that is opposite the first side of the first bus bar, and
wherein the second fuse is attached to a first side of the second bus bar and the second connection post is attached to a second side of the second bus bar that is opposite the first side of the second bus bar.

3. The power converter assembly of claim 1, further comprising:
a third connection post attached to the first bus bar and a fourth connection post attached to the second bus bar.

4. The power converter assembly of claim 1, wherein the first bus bar and the first support plate have a stepped arrangement, the first support plate and the second bus bar have a stepped arrangement, and the second bus bar and the second support plate have a stepped arrangement.

5. The power converter assembly of claim 1, wherein the casing comprises a housing base, and
wherein the gland housing and the fuse group assembly are mounted to the housing base.

6. The power converter assembly of claim 1, wherein the cable gland projects from an exterior of the gland housing.

7. The power converter assembly of claim 1, wherein the cable gland is one of a plurality of cable glands defined in the gland housing.

8. The power converter assembly of claim 1, wherein the first connection post is electrically connected to one of a positive terminal or a negative terminal of the power converter, and the second connection post is electrically connected to the other of the positive terminal or the negative terminal.

9. The power converter assembly of claim 1, wherein the first fuse is configured to interrupt a first current path on a positive side of a machine accessory, and the second fuse is configured to interrupt a second current path on a negative side of the machine accessory.

10. The power converter assembly of claim 1, wherein the power converter includes an inverter.

11. A fuse group assembly, comprising:
a first bus bar;
a second bus bar in a stepped arrangement with the first bus bar;
a first support plate arranged on the second bus bar;
a second support plate in a stepped arrangement with the first support plate;
a first fuse having a first end electrically connected to the first bus bar and a second end supported by the first support plate; and
a second fuse having a first end electrically connected to the second bus bar and a second end supported by the second support plate.

12. The fuse group assembly of claim 11, wherein the first fuse is attached to the first bus bar and the second fuse is attached to the second bus bar.

13. The fuse group assembly of claim 11, further comprising:
a first insulating pillar projecting from the first support plate,
wherein the first fuse is supported on the first insulating pillar; and
a second insulating pillar projecting from the second support plate,
wherein the second fuse is supported on the second insulating pillar.

14. The fuse group assembly of claim 11, wherein the first bus bar is positioned at a first height, the first support plate is positioned at a second height lower than the first height, the second bus bar is positioned at a third height lower than the second height, and the second support plate is positioned at a fourth height lower than the third height.

15. The fuse group assembly of claim 11, wherein the first fuse is one of a plurality of first fuses electrically connected to the first bus bar and supported on the first support plate, and
wherein the second fuse is one of a plurality of second fuses electrically connected to the second bus bar and supported on the second support plate.

16. A machine, comprising:
a power source configured to output electrical power;
a power converter electrically coupled to the power source; and
a fuse group assembly, comprising:
a first bus bar electrically connected to one of a positive terminal or a negative terminal of the power converter;
a second bus bar, in a stepped arrangement with the first bus bar, electrically connected to the other of the positive terminal or the negative terminal of the power converter;
a first support plate arranged on the second bus bar;
a second support plate in a stepped arrangement with the first support plate;
a first fuse having a first end electrically connected to the first bus bar and a second end supported by the first support plate; and
a second fuse having a first end electrically connected to the second bus bar and a second end supported by the second support plate.

17. The machine of claim 16, wherein the power source includes an internal combustion engine and an electrical generator coupled to the internal combustion engine.

18. The machine of claim 16, wherein the first bus bar and the first support plate have a stepped arrangement, the first support plate and the second bus bar have a stepped arrangement, and the second bus bar and the second support plate have a stepped arrangement.

19. The machine of claim 16, further comprising a casing,
wherein the power converter is in the casing, and
wherein the fuse group assembly is mounted to the casing.

20. The machine of claim 19, wherein the casing comprises a housing base, and
wherein the fuse group assembly is disposed in a gland housing mounted to the housing base.
